(19) United States
(12) Patent Application Publication
(10) Pub. No.: US 2005/0002289 A1
(43) Pub. Date: Jan. 6, 2005

(54) Optical pickup moving unit, optical disk apparatus, and method of manufacturing optical disk apparatus

(75) Inventor: Taiki Mori, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 10/843,640

(22) Filed: May 12, 2004

(30) Foreign Application Priority Data
May 13, 2003 (JP) P 2003-134136

(51) Int. Cl. G11B 7/00

(52) U.S. Cl. 369/44.23; 369/44.32

(57) ABSTRACT

An optical pickup moving unit holds an optical pickup head including a focusing optical system for converging a light beam emergent from a light source onto an optical recording medium and a photodetector for receiving the light beam reflected from the optical recording medium and outputting an electric current. The angle of disposition of a collimator lens in the focusing optical system is made adjustable. By adjusting the angle of disposition of the collimator lens, the direction of astigmatism at an emergent wavefront from the focusing optical system is set in an angular range of −7 degrees to +7 degrees with respect to a tangential direction which is a circumferential direction of the optical recording medium, and in an angular range including an installing position where the jitter of a reproduction signal detected and reproduced by the photodetector becomes minimum.

### BACKGROUND OF THE INVENTION

1. Field of the Invention

The present invention relates to an optical pickup moving unit, an optical disk apparatus, and a method of manufacturing an optical disk apparatus which make it possible to reduce jitter.

2. Description of the Related Art

As an optical disk apparatus using an optical pickup, a CD (Compact Disk) apparatus, a DVD (Digital Versatile Disk) apparatus, and the like are known. In the standards of the CD apparatus and the DVD apparatus, a jitter value or an amount of jitter is set for evaluating a CD or a DVD or apparatus using them.

The jitter value in the case of the CD is determined as follows. Lands and pits, i.e., data which are recorded on a CD medium, are an enumeration of “0s” and “1s.” The row of “0s” and “1s” is defined to be a succession in 3s to 11s, which is expressed by a unit of 3T to 11T. For example, although 3T data are present in large numbers on CD media, their lengths do not accurately coincide with each other physically, and have variations of subtle lengths. For this reason, the temporal width of each 3T varies. In addition, the temporal fluctuations of 3T occur due to optical factors such as the interference between codes, waveform distortion, disturbances, and the like, as well as mechanical factors such as the irregular rotation of a spindle motor, the eccentricity of the disk, and so forth.

The jitter in the case of the CD refers to the temporal fluctuation of 3T. This jitter has not continuity as indicated by the aforementioned causes of occurrence. For this reason, a standard deviation is calculated by using the technique of statistical processing of stored data on random temporal width variations, and its one sigma value is set as the jitter value. It should be noted that in the CD and CD-ROM standards, the jitter value is set to be 3 ns (nanoseconds) or less.

Meanwhile, an all T mode in which all the pits of 3T to 14T are measured by a TIA (Time Interval Analyzer) is defined in a DVD book of standards. In this DVD, since the number of bits, which serves as a basis, changes in the manner of 3T to 14T, an evaluation cannot be made by an absolute value. Therefore, temporal fluctuations of the signal are subjected to statistical processing in a case where a corresponding clock period is set to 100%, and its one signal value is expressed by a % value.

As for this jitter value or jitter amount, the smaller their values, the more excellent the recording quality and the reproduction quality are. For example, JP-A-10-106012 discloses an invention in which, by making use of the jitter amount of an HF signal obtained from a photodetector, a coupling lens and a laser light source are moved so that the jitter amount becomes minimum, so as to correct spherical aberrations of the lens. In addition, JP-A-2000-90462 discloses an invention in which the jitter amount is detected from an RF signal serving as a reproduction signal so as to effect the tilt correction of the optical disk. Thus, the optical disk apparatus is adjusted so that the jitter which occurs is minimized.

On the other hand, in the optical pickup used in the optical disk apparatus, astigmatism occurs since a lens is used. It is known that this astigmatism constitutes a cause of occurrence of an offset with respect to a DPD (Differential Phase Detection) error signal in the DPD detection in a 2PD (Photodiode) system (refer to JP-A-2001-52369).

In this JP-A-2001-52369, to suppress the occurrence of an offset in the DPD signal, the magnitude of the astigmatism of a collimator lens and the angle of astigmatism are first measured, and an average angle of astigmatism from a lens reference position is determined in a lot unit. Then, the collimator lens is mounted so that the direction of this average angle becomes identical with a radial or tangential direction on the disk surface. Subsequently, variations of factors causing the offset are controlled, and the collimator lens and the objective lens are assembled.

As shown in JP-A-10-106012 and JP-A-2000-90462, it is known that various optical aberrations and tilt after the jitter, and adjustment of the mechanism is performed so that the jitter value and the jitter amount become small. However, if the optical pickup is assembled while measuring the jitter value and the jitter amount, the assembly efficiency declines substantially and the cost also increases. Moreover, an expensive jitter meter becomes necessary in the measurement of jitter, so that the manufacturing cost increases further.

In addition, as shown in JP-A-2001-52369, a method is known in which the collimator lens is disposed at a predetermined angle, various variations of factors causing the offset are controlled, and the collimator lens and the objective lens are assembled. However, this method is not designed to reduce the jitter, control of variations is not easy, and assembly is difficult.

### SUMMARY OF THE INVENTION

The invention overcomes the above-described problems, and its object is to provide an optical pickup moving unit, an optical disk apparatus, and a method of manufacturing an optical disk apparatus which make it possible to reduce jitter, facilitate manufacture, and make it difficult for the cost to increase.

To attain the above object, in accordance with the invention there is provided an optical pickup moving unit for holding an optical pickup head including a light source, a focusing optical system for converging a light beam emergent from the light source onto an optical recording medium, and a photodetector for receiving the light beam reflected from the optical recording medium and outputting an electric current, characterized in that an angle of disposition of a collimator lens in the focusing optical system is made adjustable, and by adjusting the angle of disposition of the collimator lens, a direction of astigmatism at an emergent wavefront from the focusing optical system is set in an angular range of −7 degrees to +7 degrees with respect to a tangential direction which is a circumferential direction of the optical recording medium, and in an angular range including an installing position where the jitter of a reproduction signal detected and reproduced by the photodetector becomes minimum.

Thus, the jitter is reduced as the direction of astigmatism at the emergent wavefront from the focusing optical system is merely set on the side of the tangential direction which is the circumferential direction of the optical recording medium. Moreover, since the astigmatism direction is set in a predetermined range including a position where the jitter becomes minimum and in an angular range of −7 degrees to +7 degrees with respect to the tangential direction, it is possible to reduce the jitter reliably and substantially. Furthermore, since the jitter is reduced by adjusting the astigmatism direction at the emergent wavefront, the manufacture is facilitated, and an increase in cost is made difficult to occur. In addition, since the angle of disposition of the collimator lens is adjusted, adjustment is facilitated in comparison with the adjustment of the objective lens.

In another optical pickup moving unit for holding an optical pickup head including a light source, a focusing optical system for converging a light beam emergent from the light source onto an optical recording medium, and a photodetector for receiving the light beam reflected from the optical recording medium and outputting an electric current, a direction of astigmatism at an emergent wavefront from the focusing optical system is disposed on a tangential side which is a circumferential side of the optical recording medium rather than on a radial side thereof.

In the invention, the jitter is reduced as the direction of astigmatism at the emergent wavefront from the focusing optical system is merely set on the tangential side which is the circumferential side of the optical recording medium. Moreover, since the jitter is reduced by adjusting the astigmatism direction at the emergent wavefront, the manufacture is facilitated, and an increase in cost is made difficult to occur.

Further, in another aspect of the invention, in addition to the optical pickup moving unit of the above-described invention, the direction of astigmatism is set in an angular range of −37.5 degrees to +37.5 degrees with respect to the tangential direction. Since the angular range is set in the range of −37.5 degrees to +37.5 degrees, the margin at the time of adjustment becomes large, so that assembly is facilitated.

Further, in another aspect of the invention, in addition to the optical pickup moving unit of the above-described invention, an angle of disposition of a collimator lens in the focusing optical system is made adjustable, and by adjusting the angle of disposition of the collimator lens, the direction of astigmatism is set on the tangential side. If this arrangement is adopted, it is possible to easily adjust the direction of astigmatism at the emergent wavefront from the focusing optical system.

In addition, it is preferable to set the direction of astigmatism in an angular range of −22.5 degrees to +22.5 degrees with respect to the tangential direction. If this arrangement is adopted, the direction of astigmatism is set in an angular range where the jitter reduction effect is large, so that the jitter can be reduced substantially.

Further, it is preferable to set the direction of astigmatism in an angular range of −7 degrees to +7 degrees with respect to the tangential direction. If this arrangement is adopted, the direction of astigmatism is set in an angular range where the jitter reduction effect is extremely large, so that the jitter can be reduced further.

In addition, preferably, the angular range includes a position where the jitter of a reproduction signal obtained on the basis of an electric current detected by the photodetector becomes minimum. If this arrangement is adopted, the angular range is set in such a range that includes a position where the jitter becomes minimum, so that it is possible to reliably lower the jitter.

In addition, an optical disk apparatus in accordance with the invention includes: an optical pickup moving unit for holding an optical pickup head including a light source, a focusing optical system for converging a light beam emergent from the light source onto an optical recording medium, and a photodetector for receiving the light beam reflected from the optical recording medium and outputting an electric current; a sliding feed mechanism for moving the optical pickup moving unit in a radial direction of the optical recording medium; and a reproducing circuit for generating and outputting a reproduction signal on the basis of an electric current obtained by the photodetector, wherein an angle of disposition of a collimator lens in the focusing optical system is made adjustable, and by adjusting the angle of disposition of the collimator lens, a direction of astigmatism at an emergent wavefront from the focusing optical system is set in an angular range of −22.5 degrees to +22.5 degrees with respect to a tangential direction which is a circumferential direction of the optical recording medium, and in an angular range including an installing position where the jitter of the reproduction signal outputted from the reproducing circuit becomes minimum.

Thus, the jitter is reduced as the direction of astigmatism at the emergent wavefront from the focusing optical system is merely set on the tangential side which is the circumferential side of the optical recording medium. Moreover, since the astigmatism direction is set in a predetermined range including a position where the jitter becomes minimum and in an angular range of −7 degrees to +7 degrees where the reduction effect is large, it is possible to reduce the jitter reliably and substantially. In addition, since the jitter is reduced by adjusting the astigmatism direction at the emergent wavefront, the manufacture is facilitated, and an increase in cost is made difficult to occur. Further, adjustment is facilitated since the angle of disposition of the collimator lens is adjusted. Furthermore, with this optical disk apparatus, since the jitter of the reproduction signal is reduced, the signal reproduction stabilizes, and it is possible to obtain a high-quality reproduction signal.

In addition, a method of manufacturing an optical disk apparatus including an optical pickup moving unit for holding an optical pickup head including a light source, a focusing optical system for converging a light beam emergent from the light source onto an optical recording medium, and a photodetector for receiving the light beam reflected from the optical recording medium and outputting an electric current, a sliding feed mechanism for moving the optical pickup moving unit in a radial direction of the optical recording medium, and a reproducing circuit for generating and outputting a reproduction signal on the basis of an electric current obtained by the photodetector, includes the steps of: making a collimator lens in the focusing optical system rotatable at a pitch of 45 degrees; causing a set margin of angle of the collimator lens including an optimum position of the collimator lens based on an amount of jitter of the reproduction signal detected by the photodetector to be set in a range exceeding 45 degrees; and causing the collimator lens to rotate at the pitch of 45 degrees, whereby a direction of astigmatism at an emergent wavefront from the focusing optical system is positioned on a tangential side which is a circumferential side of the optical recording medium and within the set margin of angle.

If this manufacturing method is adopted, an optical disk apparatus with reduced jitter can be manufactured easily and with practically no increase in cost. In particular, by merely rotating the collimator lens at a pitch of 45 degrees, the direction of astigmatism can be positioned on the tangential side to allow the jitter to decrease, so that the manufacture is extremely facilitated.

Another method of manufacturing an optical disk apparatus including an optical pickup moving unit for holding an optical pickup head including a light source, a focusing optical system for converging a light beam emergent from the light source onto an optical recording medium, and a photodetector for receiving the light beam reflected from the optical recording medium and outputting an electric current, a sliding feed mechanism for moving the optical pickup moving unit in a radial direction of the optical recording medium, and a reproducing circuit for generating and outputting a reproduction signal on the basis of an electric current obtained by the photodetector, includes the steps of: rotating at least one of lenses of the focusing optical system at each predetermined angle to make rotatable a direction of astigmatism at an emergent wavefront of the focusing optical system; causing a set margin of angle of the focusing optical system including an optimum position of the focusing optical system in the astigmatism direction where the jitter of the reproduction signal detected by the photodetector becomes minimum to be set in a range exceeding the predetermined angle; and causing the lens in the focusing optical system to rotate at a pitch of the predetermined angle, whereby the direction of astigmatism is positioned on a tangential side which is a circumferential side of the optical recording medium and within the set margin of angle.

If this manufacturing method is adopted, an optical disk apparatus with reduced jitter can be manufactured easily and with practically no increase in cost. In particular, since it suffices to merely rotate the direction of astigmatism at the emergent wavefront from the focusing optical system, it is possible to obtain the jitter reduction effect simply and easily.

### BRIEF DESCRIPTION OF THE DRAWINGS

These and other objects and advantages of this invention will become more fully apparent from the following detailed description taken with the accompanying drawings in which:

FIG. 1 is a plan view, as taken from an optical recording medium side, of an optical pickup moving unit in accordance with an embodiment of the invention;

FIG. 2 is a schematic side diagram of essential portions of the optical pickup moving unit shown in FIG. 1;

FIG. 3 is a diagram illustrating a planar state of a collimator lens used in the optical pickup moving unit shown in FIG. 1, and defining the direction of astigmatism of the lens;

FIG. 4 is a diagram illustrating an emergent wavefront of a light beam made emergent from the optical pickup moving unit shown in FIG. 1, and defining the direction of astigmatism (Asθ) at that emergent wavefront;

FIG. 5 is a diagram illustrating the relationship between jitter and the direction of astigmatism (Asθ) at that emergent wavefront of the light beam made emergent from the optical pickup moving unit shown in FIG. 1, as well as the relationship between that astigmatism direction (Asθ) and an astigmatism amount (As) at the emergent wavefront; and

FIG. 6 is a diagram illustrating the relationship among the jitter, an attaching angle of the collimator lens used in the optical pickup moving unit shown in FIG. 1, and a specification of the jitter of an optical disk apparatus.

### DETAILED DESCRIPTION OF THE PREFERRED EMBODIMENTS

Referring now to the drawings, a description will be given of an optical pickup moving unit in accordance with an embodiment of the invention. It should be noted that an optical disk apparatus and a method of manufacturing an optical disk in accordance with the invention will be described in conjunction with the description of the optical pickup moving unit.

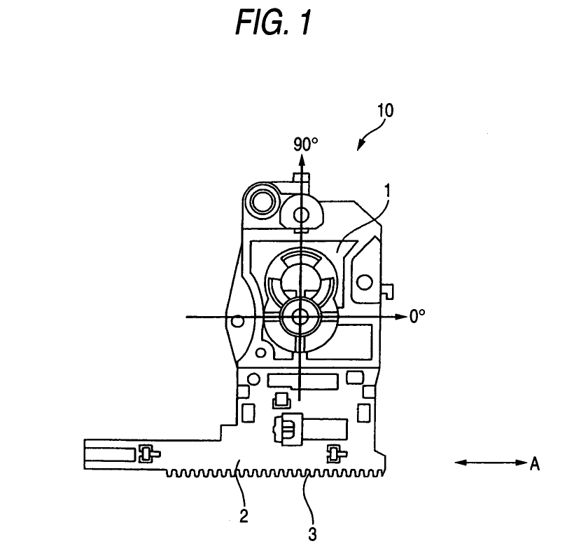

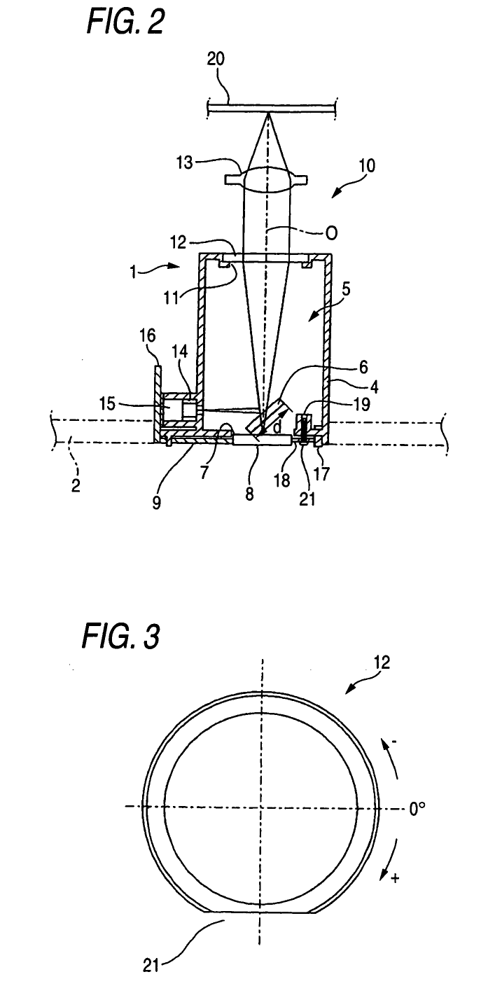

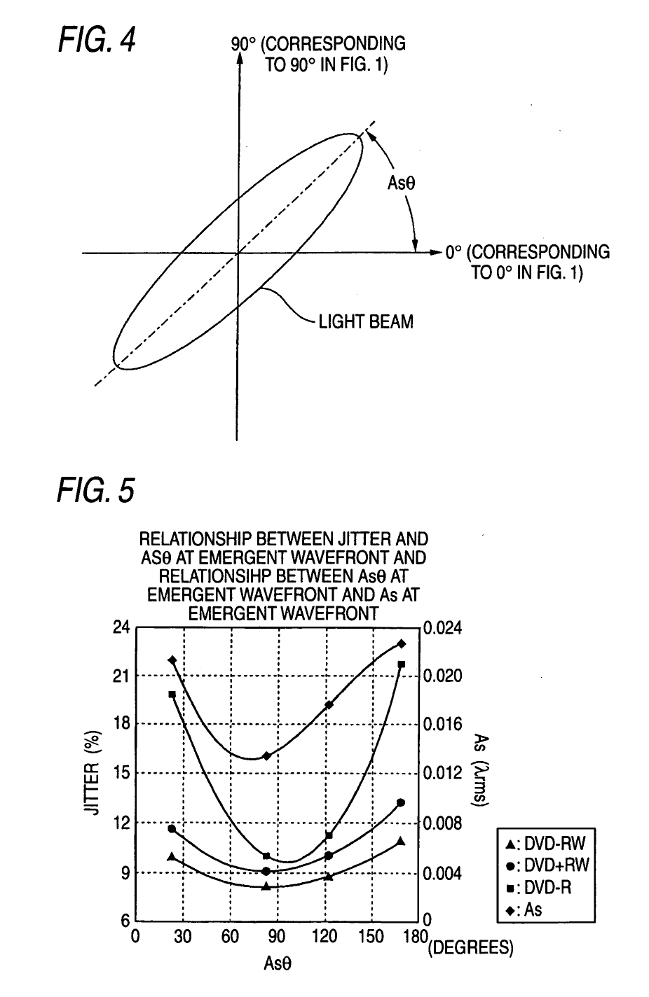

FIG. 1 is a plan view, as taken from an optical recording medium 20 side, of an optical pickup moving unit 10 in accordance with the embodiment of the invention. FIG. 2 is a schematic side diagram of essential portions of the optical pickup moving unit 10. It should be noted that, in this example, the optical pickup moving unit 10 is that for a DVD, and a DVD is used as the optical recording medium 20.

The optical pickup moving unit 10 is included of an optical pickup head 1 and a holding portion 2 for holding this optical pickup head 1 substantially in its center. A rack 3 is formed on the holding portion 2, and the arrangement provided is such that a gear for transmitting an output from a feed motor (not shown) meshes with this rack 3. Further, the optical pickup moving unit 10 is arranged to reciprocatingly move in the direction of arrow A in FIG. 1.

This direction of arrow A is the radial direction of the optical recording medium 20, and coincides with the direction of an arrow indicating 0 degree. The direction indicated as 90 degrees in FIG. 1, which is a direction perpendicular to the radial direction, i.e., the direction of arrow A, is set as a tangential direction. This tangential direction coincides with a direction along a track of the optical recording medium 20. The indication of 0 degree to 90 degrees is made to agree with the definition of the angle of an emergent wavefront which will be described later.

The optical pickup moving unit 10 is formed of a synthetic resin material. The optical pickup head 1 portion of the optical pickup moving unit 10 has a configuration shown in FIG. 2. Namely, the optical pickup head 1 has a main housing 4, and a half mirror 6 is disposed in an inclined manner in a light passage hole 5 of this main housing 4. A photodiode 8 serving as a photodetector for receiving a light beam reflected by the optical recording medium 20 and for outputting an electric current is disposed in an end opening 7 of the light passage hole 5, and a metallic substrate 9 of the photodiode 8 is fixed to the main housing 4. A collimator lens 12 and an objective lens 13 are disposed on another end opening 11 side of the main housing 4. The collimator lens 12 is adhered and fixed to the main housing 4. A drive coil and a magnet for driving which are not shown are disposed in vicinities of the objective lens 13 to allow the objective lens 13 to effect tracking operation and focusing operation.

Here, the half mirror 6, the collimator lens 12, and the objective lens 13 constitute a focusing optical system for converging the light beam emergent from a light source onto the optical recording medium 20. This focusing optical system may adopt a configuration in which a diffraction grating, a phase plate, a cylindrical lens, and the like are added, as required, in addition to the above-described configuration.

A branch hole 14 is formed in a side surface of the main housing 4, and a semiconductor laser 15 which serves as a light source is accommodated in that branch hole 14. A metallic substrate 16 of the semiconductor laser 15, as well as the metallic substrate 9 of the photodiode 8 disposed in the end opening 7, are disposed in close proximity to or in abutment against each other.

The metallic substrate 9 of the photodiode 8 is rectangular, and its peripheral portions are fixed to the main housing 4 by means of set screws 17. A substantially U-shaped slit is formed in a central portion of the metallic substrate 9, and the photodiode 8 is secured to a resiliently deformable tongue 18 which has been cut out. An adjustment screw 21 is passed through the tongue 18, and is threadedly engaged with a threaded hole 19 in the main housing 4. By adjusting the amount of screwing-in of this adjustment screw 21, it is possible to finely adjust the position of the photodiode 8.

The metallic substrate 16 of the semiconductor laser 15 is rectangular and is fixed to the main housing 4 by means of set screws (not shown). In addition, a lower edge of this metallic substrate 16 in FIG. 2 is in close proximity to or in abutment against the metallic substrate 9.

As shown in FIG. 3, the collimator lens 12 in terms of its shape is substantially circular as a whole and has a cutoff portion 21 formed by cutting off a portion of it. In the optical pickup head 1, this collimator lens 12 is adapted to be rotated at a pitch of 45 degrees in its circumferential direction in order to be capable of changing its installation position. It should be noted that the indication of 0 degree and + and − shown in FIG. 3 shows the definition of the astigmatism angle of this collimator lens 12.

According to the construction of the above-described optical pickup head 1, the vertical interval in FIG. 2 between the photodiode 8 disposed in the end opening 7 and the semiconductor laser 15 accommodated in the branch hole 14 is set to be small in the vicinity of 6 mm to 4 mm, for example. For this reason, the half mirror 6 opposing the semiconductor laser 15 is disposed shallowly at a position close to the end opening 7 in the light passage hole 5. Hence, the half mirror 6 can be easily removed from that end opening 7, thereby making it possible to perform maintenance operation efficiently.

In addition, the adjustment of the angle of disposition of the collimator lens 12 can also be carried out easily by making use of the other end opening 11. Further, since the half mirror 6 is disposed close to the photodiode 8, the half mirror 6 is sufficient even if its width d is small, so that the material cost can be reduced.

In addition, as the branch hole 14 is formed close to the end opening 7, the metallic substrate 16 of the semiconductor laser 15 accommodated in this branch hole 14, as well as the metallic substrate 9 of the photodiode 8 disposed in the end opening 7, can be disposed in close proximity to or in abutment against each other. For this reason, the heat generated by the semiconductor laser 15 is actively dissipated to the atmosphere by means of both metallic substrates 9 and 16. Consequently, the possibility of the main housing 4 becoming thermally expanded and deformed due to the heat generation of the semiconductor laser 15 is eliminated, so that the optical axis O connecting the photodiode 8 and the objective lens 13 can be maintained in a rectilinear state, as required, in the same way as the case of the conventional metallic main housing. By virtue of this construction, it is possible to prevent the occurrence of a read error. In addition, it is possible to form the optical pickup moving unit 10 of high accuracy, low cost, and low weight by virtue of the above-described construction.

FIG. 4 shows an emergent wavefront of the light beam made emergent from the objective lens 13 of the optical pickup moving unit 10 having the above-described construction toward the optical recording medium 20. The emergent wavefront surface of the optical beam shown in FIG. 4 shows a state in the vicinity of the optical recording medium 20. Although the emergent wavefront of the light beam made emergent from the objective lens 13 is initially substantially circular, the emergent wavefront in the vicinity of a focal point assumes a state shown in FIG. 4 owing to the astigmatism of the focusing optical system.

In the optical pickup moving unit 10 having the above-described construction, when the relationship between the amount of jitter and the astigmatism angle (Asθ) which becomes the astigmatism direction of the emergent wavefront of the light beam emergent from the objective lens was determined by measurement in an all T mode, the relationship shown in FIG. 5 was obtained. As shown in FIG. 5, the amount of jitter decreases as the astigmatism angle (Asθ) at the emergent wavefront from the focusing optical system approaches the 90-degree direction (tangential direction) shown in FIG. 1. FIG. 5 also shows the relationship between the astigmatism angle (Asθ) and the astigmatism amount (As) at the emergent wavefront.

In the example shown in FIG. 5, a DVD-R which is of the recordable type and can be written only once, as well as a DVD−RW and a DVD+RW which are of the rewritable type and can be overwritten about 1000 times, were used as the DVDs. Further, the data shown in FIG. 5 was obtained by using three optical pickup moving units 10 and by rotating each collimator lens 12 at the pitch of 45 degrees with respect to the main housing 4. As the collimator lens 12 was rotated, the astigmatism direction (Asθ) at the emergent wavefront of the light beam made emergent from the objective lens 13 changed, and an average of the three units is shown is FIG. 5. It should be noted that the objective lens 13 is fixed in a state of being at an optimally attached angle.

As shown in the graph of FIG. 5 in which respective points are connected by approximation, the astigmatism direction in which the amount of jitter becomes minimum was 83.879 degrees in the case of the DVD−RW, was 82.551 degrees in the case of the DVD+RW, and was 94.956 degrees in the case of the DVD-R. Thus, the amount of jitter decreases if the astigmatism direction (astigmatism angle) is adjusted to the 90-degree side which is the tangential direction. On the basis of the result of FIG. 5, the optical pickup moving unit 10 in accordance with this embodiment decreases the amount of jitter by adjusting the attaching angle (=angle of disposition) of the collimator lens 12 with respect to the main housing 4.

Specifically, the following adjustment is made to adjust the astigmatism direction not to the radial side but the tangential side. First, the collimator lens 12 is attached to a predetermined position on the main housing 4 by temporary fixation. Then, the astigmatism angle (Asθ) at the emergent wavefront of the light beam made emergent from the objective lens 13 is detected. The collimator lens 12 is further rotated by 45 degrees when that value does not fall within ±22.5 degrees with respect to the tangential direction (90 degrees in FIGS. 1 and 4), i.e., does not fall within an angular range of 45 degrees ranging from 67.5 degrees to 112.5 degrees.

The astigmatism direction is made to fall within the angular range of 67.5 degrees to 112.5 degrees by rotating the collimator lens 12 at the pitch of 45 degrees in the above-described manner. Thus, the astigmatism direction is set to the tangential direction. Subsequently, the collimator lens 12 is fixed by being attached to the main housing 4. It should be noted that if the astigmatism direction is not set to the angular range of 45 degrees falling within the angular range of 67.5 degrees to 112.5 degrees, but set to an angular range of less than +45 degrees with respect to the tangential direction (90 degrees), the astigmatism direction is disposed not on the radial side but on the tangential side, which is preferable.

Next, a description will be given of the relationship with the present specifications of the DVD apparatus in the case where the astigmatism direction is thus adjusted.

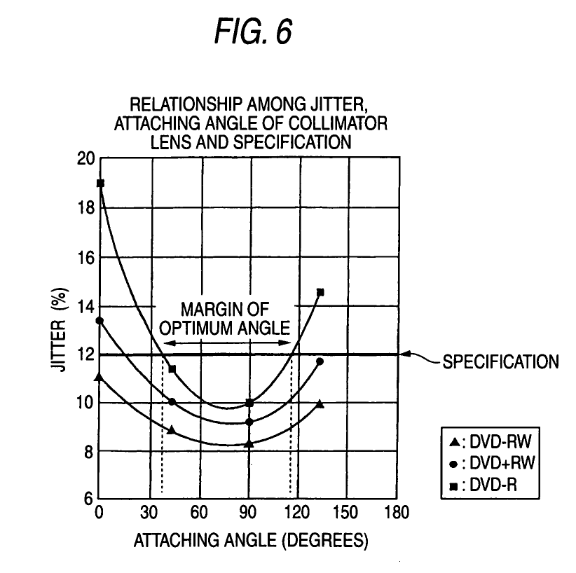

The collimator lens 12 was attached to the main housing 4 at the pitch of 45 degrees, and the amount of jitter due to the light beam emergent from the optical pickup moving unit 10 was measured based in the all T mode. The results are shown in FIG. 6. The attaching angle constituting the abscissa shows an angle at which the collimator lens 12 is rotated with respect to a reference position (the position of 0 degree shown in FIG. 6) of the collimator lens 12, and shows that measurement was made at the respective positions of 0 degree, 45 degrees, 90 degrees, and 135 degrees. Meanwhile, the ordinate shows the amount of jitter at each position.

As shown in FIG. 6, when the specification concerning jitter is set to 12% or less, in the case of the DVD-R, which produces the largest amount of jitter, the angular range in which the jitter level becomes 12% or less is 75 degrees (39 degrees to 114 degrees in FIG. 6), and a margin of an optimum angle (=set margin of angle) becomes 75 degrees. This set margin of angle becomes ±37.5 degrees with respect to a minimum jitter position where the jitter level becomes minimum.

Since the attachment of the collimator lens 12 is set at the pitch of 45 degrees with respect to this set margin of angle, 30 degrees, which is obtained by subtracting 45 degrees from 75 degrees, becomes the margin of angle at the time of attachment. Namely, even if an attachment error of 15 degrees occurs on the left and the right, respectively, (±15 degrees), the amount of jitter is contained within the specification.

As the astigmatism direction is set not to the angular range of not ±45 degrees or less but ±37.5 degrees with respect to the tangential direction, the specification concerning jitter can be met for each DVD. In addition, in the case where the collimator lens 12 is made rotatable at the pitch of 45 degrees, a margin of ±15 degrees can be provided with respect to this specification. If it is desirable to set the margin of angle to zero, it suffices if this angular range is set to ±22.5 degrees instead of ±37.5 degrees. By so doing as well, it is basically possible to manufacture a DVD apparatus which meets the present specification of the DVD. In addition, if the collimator lens 12 is thus made rotatable at the pitch of 45 degrees, adjustment is facilitated in comparison with the adjustment of the objective lens 13, thereby reducing the manufacturing cost.

In addition, as shown in FIG. 5, the astigmatism direction in which the jitter level becomes minimum is in the range of −7.5 degrees to +5 degrees with respect to the tangential direction. Therefore, if the angular range of the astigmatism direction with respect to the tangential direction is set to ±7 degrees, it is possible to provide the optical pickup moving unit 10 which remarkably reduces jitter for each DVD. It should be noted that if a more reliable angular range is to be set in light of the measurement results, it is preferable to set the astigmatism direction in the angular range of −7.5 degrees to +5 degrees.

The following are the mechanical properties and optical properties of the collimator lenses 12 and the objective lenses 13 of the three optical pickup moving units 10 used in the above-described measurements (FIGS. 5 and 6). Namely, PV (Peak-to-Valley) values, which are figure tolerances (shape errors of processed surfaces with respect to ideal surfaces) of the collimator lenses, were 0.238λ, 0.219λ, and 0.213λ, and RMS (Root Mean Square) values were 0.039λ rms, 0.034λ rms, and 0.034λ rms. Further, astigmatism amounts (As) were 0.035λ rms, 0.030λ rms, and 0.030λ rms, while astigmatism directions (Asθ) were 16 degrees, 13 degrees, and 17 degrees according to the angles defined in FIG. 3.

In addition, PV values of the three objective lenses 13 were 0.152λ, 0.151λ, and 0.171λ, and RMS values were 0.024λ rms, 0.024λ rms, and 0.023λ rms. Further, astigmatism amounts (As) which are optical properties of the respective objective lenses 13 were 0.009λrms, 0.009λ rms, and 0.007λ rms, while astigmatism angles (Asθ) which become directions of astigmatism were 48 degrees, 52 degrees, and 52 degrees when the same definitions as those shown in FIG. 3 are used.

The optical pickup moving unit 10 having the above-described construction is used by being incorporated in the optical disk apparatus. At this time, the optical pickup moving unit 10 reciprocatingly moves in the direction of arrow A in FIG. 1 as its rack 3 receives an output from a sliding feed mechanism consisting of a feed motor and the like. Further, a reproducing circuit for generating and outputting a reproduction signal on the basis of an electric current obtained by the photodiode 8 is disposed in the optical disk apparatus. In addition, a signal recording circuit is further disposed in the case of an optical disk apparatus capable of using a recordable optical recording medium 20.

The optical pickup moving unit 10, the optical disk apparatus having the optical pickup moving unit 10, and the method of manufacturing the optical disk apparatus in accordance with the above-described embodiment of the invention are preferred examples of the invention. However, various modifications are possible within the scope that does not depart from the gist of the invention. For example, although a description has been given above by citing the DVD apparatus as an example, the reduction of jitter through the adjustment of the astigmatism direction also appears in CD apparatuses and MD apparatuses. For this reason, the adoption of a construction similar to the one described above is effective as a jitter reduction measure with respect to other types of optical disk apparatuses such as CD apparatuses and MD apparatuses.

In addition, in the above-described embodiment, the collimator lens 12 is rotated at the pitch of 4.5 degrees to adjust the emergent wavefront, but the objective lens 13 may be rotated instead. Further, in the case of the rotation, rotation may be effected at other pitch angles by adopting such as a 15-degree pitch, a 20-degree pitch, or a 30-degree pitch instead of the 45-degree pitch. Furthermore, it is possible to adopt not the step rotation at predetermined angles but continuous (linear) rotation.

Further, although in the above-described embodiment the margin of an optimum angle (=set margin of angle) is set to 75 degrees, the set margin of angle assumes another value if another collimator lens or another objective lens is used, or the specifications are made different, so that the set margin of angle maybe set to assume another angle. It should be noted that this set margin of angle may be set to a level slightly smaller than the aforementioned pitch angle, but it is not preferable to set it to an extremely small level. Preferably, the set margin of angle is set in a range that exceeds the aforementioned pitch angle.

In addition, as the sliding feed mechanism, instead of the linear rack 3 in the above-described embodiment, it is possible to adopt another sliding feed mechanism such as a feed screw system, a swing arm system, or a linear motor system. Further, as the optical disk apparatus, instead of the light-beam reflecting system described above, it is possible to adopt a system in which the light passes through the optical recording medium.

In the invention, it is possible to obtain an optical pickup moving unit and an optical disk apparatus which make it possible to reduce jitter, facilitate manufacture, and make it difficult for the cost to increase. In addition, if the manufacturing method in accordance with the invention is adopted, it is possible to easily manufacture an optical pickup moving unit which makes it possible to reduce jitter and entails practically no increase in cost. Consequently, it is possible to obtain an optical disk apparatus with reduced jitter by suppressing an increase in cost.

1. An optical pickup moving unit for holding an optical pickup head comprising:
a light source;
a focusing optical system for converging a light beam emergent from the light source onto an optical recording medium; and
a photodetector for receiving the light beam reflected from the optical recording medium and outputting an electric current, wherein
an angle of disposition of a collimator lens in the focusing optical system is made adjustable, and by adjusting the angle of disposition of the collimator lens, a direction of astigmatism at an emergent wavefront from the focusing optical system is set in an angular range of −7 degrees to +7 degrees with respect to a tangential direction which is a circumferential direction of the optical recording medium, and in an angular range including an installing position where the jitter of a reproduction signal detected and reproduced by the photodetector becomes minimum.

2. An optical pickup moving unit for holding an optical pickup head comprising:
a light source;
a focusing optical system for converging a light beam emergent from the light source onto an optical recording medium; and
a photodetector for receiving the light beam reflected from the optical recording medium and outputting an electric current, wherein
a direction of astigmatism at an emergent wavefront from the focusing optical system is disposed on a tangential side which is a circumferential side of the optical recording medium rather than on a radial side thereof.

3. The optical pickup moving unit according to claim 2, wherein
the direction of astigmatism is set in an angular range of −37.5 degrees to +37.5 degrees with respect to the tangential direction.

4. The optical pickup moving unit according to claim 2, wherein
an angle of disposition of a collimator lens in the focusing optical system is made adjustable, and by adjusting the angle of disposition of the collimator lens, the direction of astigmatism is set on the tangential side.

5. The optical pickup moving unit according to claim 4, wherein
the direction of astigmatism is set in an angular range of −22.5 degrees to +22.5 degrees with respect to the tangential direction.

6. The optical pickup moving unit according to claim 5, wherein
the direction of astigmatism is set in an angular range of −7 degrees to +7 degrees with respect to the tangential direction.

7. The optical pickup moving unit according to claim 5, wherein
the angular range includes a position where the jitter of a reproduction signal obtained on the basis of an electric current detected by the photodetector becomes minimum.

8. An optical disk apparatus comprising:
an optical pickup moving unit for holding an optical pickup head including:
a light source;
a focusing optical system for converging a light beam emergent from the light source onto an optical recording medium; and
a photodetector for receiving the light beam reflected from the optical recording medium and outputting an electric current;
a sliding feed mechanism for moving the optical pickup moving unit in a radial direction of the optical recording medium; and
a reproducing circuit for generating and outputting a reproduction signal on the basis of an electric current obtained by the photodetector, wherein
an angle of disposition of a collimator lens in the focusing optical system is made adjustable, and by adjusting the angle of disposition of the collimator lens, a direction of astigmatism at an emergent wavefront from the focusing optical system is set in an angular range of −22.5 degrees to +22.5 degrees with respect to a tangential direction which is a circumferential direction of the optical recording medium, and in an angular range including an installing position where the jitter of the reproduction signal outputted from the reproducing circuit becomes minimum.

9. A method of manufacturing an optical disk apparatus including an optical pickup moving unit for holding an optical pickup head including a light source, a focusing optical system for converging a light beam emergent from the light source onto an optical recording medium, and a photodetector for receiving the light beam reflected from the optical recording medium and outputting an electric current, a sliding feed mechanism for moving the optical pickup moving unit in a radial direction of the optical recording medium, and a reproducing circuit for generating and outputting a reproduction signal on the basis of an electric current obtained by the photodetector, the method comprising:
making a collimator lens in the focusing optical system rotatable at a pitch of 45 degrees;
causing a set margin of angle of the collimator lens including an optimum position of the collimator lens where the jitter of the reproduction signal detected by the photodetector becomes minimum to be set in a range exceeding 45 degrees; and
causing the collimator lens to rotate at the pitch of 45 degrees, whereby a direction of astigmatism at an emergent wavefront from the focusing optical system is positioned on a tangential side which is a circumferential side of the optical recording medium and within the set margin of angle.

10. A method of manufacturing an optical disk apparatus including an optical pickup moving unit for holding an optical pickup head including a light source, a focusing optical system for converging a light beam emergent from the light source onto an optical recording medium, and a photodetector for receiving the light beam reflected from the optical recording medium and outputting an electric current, a sliding feed mechanism for moving the optical pickup moving unit in a radial direction of the optical recording medium, and a reproducing circuit for generating and outputting a reproduction signal on the basis of an electric current obtained by the photodetector, the method comprising:
rotating at least one of lenses of the focusing optical system at each predetermined angle to make rotatable a direction of astigmatism at an emergent wavefront of the focusing optical system;
causing a set margin of angle of the focusing optical system including an optimum position of the focusing optical system in the astigmatism direction where the jitter of the reproduction signal detected by the photodetector becomes minimum to be set in a range exceeding the predetermined angle; and
causing the lens in the focusing optical system to rotate at a pitch of the predetermined angle, whereby the direction of astigmatism is positioned on a tangential side which is a circumferential side of the optical recording medium and within the set margin of angle.
